(19) United States
(12) Patent Application Publication
(10) Pub. No.: US 2014/0337997 A1
(43) Pub. Date: Nov. 13, 2014

(54) METHOD AND SYSTEM FOR BLOCKING TRANSMISSION OF DATA ON A MOBILE DEVICE

(71) Applicant: Famigo, Inc., Austin, TX (US)

(72) Inventors: Q Newton BECK, Austin, TX (US); Douglas FERGUSON, Austin, TX (US); John Russell ISTURIZ, Austin, TX (US); Matthew Martin MCDONNELL, Austin, TX (US)

(73) Assignee: Famigo, Inc., Austin, TX (US)

(21) Appl. No.: 14/186,460

(22) Filed: Feb. 21, 2014

Related U.S. Application Data
(60) Provisional application No. 61/767,558, filed on Feb. 21, 2013.

(51) Int. Cl. G06F 21/60; H04W 12/02

(52) U.S. Cl. CPC G06F 21/60; H04W 12/02
USPC 726/27

(57) ABSTRACT

A software application stored in a memory in a mobile device for selectively blocking data transmission via a mobile device over a communication network, comprising means for identifying a software application of interest from among a plurality of software applications stored in a memory of the mobile device, means for determining a categorization of the software application of interest based on data provided over the communication network from a database, and means for selectively restricting transmission of data to or from the software application of interest over the communication network based on the determined categorization, wherein personally identifiable information is prevented from being transmitted by the software application of interest if the determined categorization indicates that transmission of date to or from the software application of interest is to be restricted.

### PRIORITY CLAIM

This application claims domestic priority based upon U.S. Provisional Patent Application Ser. No. 61/767,558, filed Feb. 21, 2013, the disclosure of which is hereby incorporated by reference.

### FIELD

The present disclosure relates to systems, components, and methodologies for selectively blocking data transmission to or from a software application stored in the memory of a mobile device. More specifically, the present disclosure is directed to systems, components, and methodologies that allow for software applications stored on a mobile device to be categorized based on their suitability for respective members of a family, and to selectively block data transmission to or from the software applications based on the category to which the software applications belong.

### BACKGROUND

Parents have long been concerned about the safety and age-suitability of mobile software applications for their children. Third party mobile software applications can transmit a variety of content to children and solicit a variety of information from children that gives rise to these concerns. Two examples of such content include advertisements and personally identifiable information (“PII”). Regarding advertisements, children are particularly susceptible to direct marketing that specifically targets children. Regarding PII, third party applications often solicit or indirectly glean information about children for purposes of behavioral analytics that can, among other things, allow the third parties to further target advertising to children. In fact, laws, such as the Children's Online Privacy Protection Act (“COPPA”), have been enacted to prevent direct marketing to children and to protect the privacy of children.

However, there is a need for improved technological systems, components, and methodologies for preventing third party applications from transmitting targeted advertisements to children or from acquiring PII from children.

### SUMMARY

According to the present disclosure, systems, components and methods are provided for allowing or disallowing data transmission to or from software applications stored on a mobile device.

Disclosed embodiments provide systems, components and methods that categorize software applications based on their suitability for children and selectively restrict data transmission to or from the application if the application is unsuitable for children.

In illustrative embodiments, a software application for selectively blocking data transmission via a mobile device over a communication network, comprises means for identifying a software application of interest from among a plurality of software applications stored in a memory of the mobile device, means for determining a categorization of the software application of interest based on data provided over the communication network from a database, and means for selectively restricting transmission of data to or from the software application of interest over the communication network based on the determined categorization, wherein personally identifiable information is prevented from being transmitted by the software application of interest if the determined categorization indicates that transmission of data to or from the software application of interest is to be restricted.

Additional features of the present disclosure will become apparent to those skilled in the art upon consideration of illustrative embodiments exemplifying the best mode of carrying out the disclosure as presently perceived.

### BRIEF DESCRIPTION OF THE FIGURES

The detailed description particularly refers to the accompanying figures in which:

FIG. 1 is a block diagram showing the environment in which an exemplary system in accordance with the disclosure operates. It shows a mobile device that contains both a software application for selectively blocking data transmission to and from third party software applications, the third party software applications, a server having a database, and a communications network over which the mobile device can communicate with the database.

FIG. 2 is a flow diagram of an exemplary method in accordance with the disclosure by which a software application interperates with a database to determine the categories in which respective third party software applications stored on the mobile device belong.

FIG. 3 shows a flow diagram of an exemplary method by which a software application selectively blocks data transmission to or from third party software applications depending on the categories to which those third party applications belong.

FIG. 4 depicts a screen that a child will see when prohibited from accessing a third party application.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

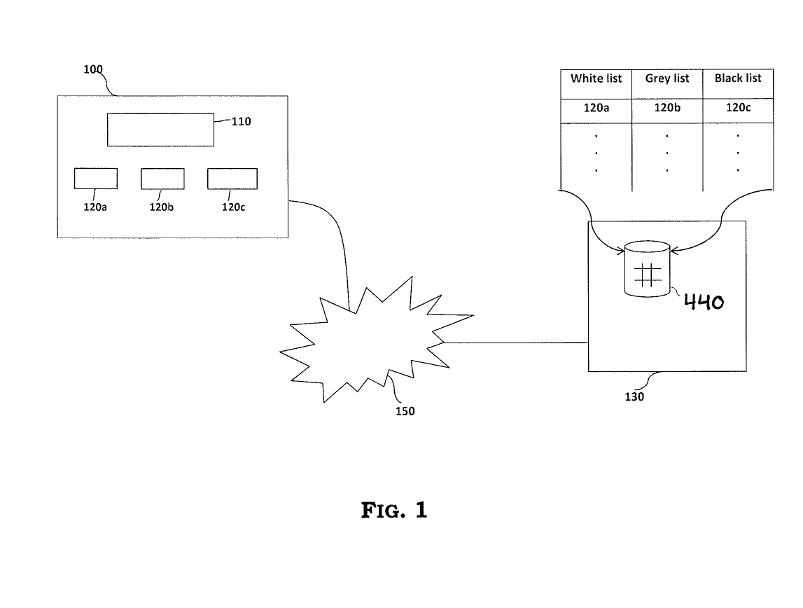

FIG. 1 shows a mobile device 100, a software application 110, a plurality of third party software applications 120a, 120b, and 120c, a server 130, a database 140, and a network 150. By way of overview, the software application 110 selectively blocks data transmission to or from third party applications 120b, 120b, and 120c. The software application 110 selects whether to and the manner in which to block data transmission to or from any given third party application 120a, 120b, or 120c based on a category to which the third party software application 120a, 120b, or 120c belongs. According to one illustrative embodiment, each of the third party software applications 120a, 120b, and 120c belongs to one of three categories, referred to herein as a “Whitelist,” a “Greylist,” and a “Blacklist.” For purposes of this illustrative embodiment, the third party application 120a belongs to the Whitelist, the third party software application 120b belongs to the Greylist, and the third party software application 120c belongs to the Blacklist.

For third party software applications belonging to the Whitelist, such as third party software application 120a, the software application 110 allows a child to launch the third party software application 120a and does not impose restrictions on the transmission of data to or from the third party software application 120a. In contrast, for third party software applications belonging to the Blacklist, such as third party software application 120c, the software application 110 prevents a child from launching the third party software application 120c. Finally, for third party software applications belonging to the Greylist, such as third party software application 120b, the software application 110 determines whether to allow the third party software application 120b to launch and/or whether to impose restrictions on the transmission of data to or from the third party application 120b based on parental preferences. The database 140 located on server 130 stores information regarding the respective category—Whitelist, Greylist, or Blacklist—to which each third party application 120a, 120b, and 120c belongs.

In one illustrative embodiment, a parent installs and configures software application 110 and makes selections for user preferences, to be discussed in more detail below. Before providing the mobile device 100 to a child, the parent may invoke the software application 110 in order to place the mobile device 100 in a “safe mode” or a “play mode.” Once in this mode, the software application 110 can selectively block transmission of data to or from third party software applications 120a, 120b, or 120c, as will be discussed in more detail below.

More particularly, according to this illustrative embodiment, mobile device 100 is implemented as a mobile smartphone, but in other embodiments may be implemented as a tablet, a PDA, a multimedia computer, a laptop, and the like. Mobile device 100 may include network connectivity, such as cellular network connectivity and/or wireless local area networking capabilities (i.e. “WiFi”). The mobile device 100 includes an operating system which may be selected from among Apple's iOS line of operating systems, the Android line of operating systems, the Windows Mobile or Windows Phone line of operating systems, or BlackBerry operating systems.

Mobile device 100 includes software application 110, which selectively blocks data transmission to or from third party applications 120a, 120b, and 120c. The software application 110 may be implemented as a mobile application (“mobile app”), which is a software program or application designed to run on computers such as smartphones, tablet computers and other mobile devices. The software application 110 may be made available through application distribution platforms operated by the owner of a mobile operating system, such as the Apple App Store, Google Play, Windows Phone Store or BlackBerry App World, from which a user downloads software application 110 to the mobile device 100. Alternatively, the software application 110 may be provided at the point of distribution of the mobile device 100, and may be part of the mobile device 100's native software. Software application 110 may be implemented in Java, C, C++, C#, shell scripts, other known programming languages, or combinations thereof:

Mobile device also includes third party software applications 120a, 120b, and 120c. Third party software applications 120a, 120b, and 120c may be developed by application developers for use on mobile device 100. As with software application 110, the third party software applications 120a, 120b, and 120c can be made available for user download through distribution platforms such as Apple App Store, Google Play, Windows Phone Store or BlackBerry App World. Though referred to herein as “third party” software applications, the third party software applications 120a, 120b, and 120c can be provided on the mobile device 100 at the time of distribution and/or as part the native software for mobile device 100. Examples of third party software applications 120a, 120b, and 120c include social media or social networking applications, gaming applications, multimedia content distribution applications, music or movie applications, podcast applications, office productivity applications, and the like.

Third party software applications 120a, 120b, and 120c may be applications that, under ordinary operating conditions on mobile devices that do not include software application 110, make use of the mobile device 100's data connectivity to receive and transmit data. The type of data received and transmitted by the third party software applications 120a, 120b, and 120c may depend on the type of application at hand. For example, a gaming application will receive and transmit gaming data, etc.

The data received and transmitted by the third party software applications 120a, 120b, and 120c may include advertisements and/or PII. The advertisements may be provided from an ad server coupled to network 150, to the third party software applications 120a, 120b, and 120c. The third party software applications 120a, 120b, and 120c display the advertisements to users of mobile device 100. PII may be provided, directly or indirectly, by a user of the mobile device 100 to the third party applications 120a, 120b, or 120c, which may transmit the PII to a server, such as a server maintained by the third party that provides the third party application 120a, 120b, or 120c. PII may include information that can identify a user of the mobile device 100 and/or characteristics of the user of the mobile device 100, such as the user's behavior, preferences, dislikes, past activities, past application usage patterns, and the like. PII may include information useful for behavioral analytics tracking. PII may be used to direct targeted advertising to a user of the mobile device 100. PII may include activity-related data of children when using their applications from the viewpoint of a mobile carrier, handset original equipment manufacturer, or mobile operating system developer.

The software application 110 may operate to selectively block the transmission of data to or from the third party applications 120a, 120b, or 120c, including advertisements and/or PII. The software application 110 determines whether to block and the manner by which to block data transmissions to or from the third party applications 120a, 120b, or 120c based on the category to which the third party application 120a, 120b, or 120c belongs. Information about the category to which the third party applications 120a, 120b, or 120c belong is stored on database 140 on server 130. Database 140 and server 130 may be implemented using any known database environment, such as Oracle, DB2, or SQL Server. Database 140 may be a relational database and server 130 may be a database server.

The software application communicates with the database through network 150. Network 150 may include any type of communication network, such as a cellular communication network, including but not limited to a second Generation (2G) network, a 2.5 Generation network, a third Generation (3G) network utilizing Global System for Mobile Communications (GSM), Wideband Code Division Multiplex Access (WCDMA), Code Division Multiplex Access (CDMA), or Time Division Multiplex Access (TDMA), General Packet Radio Services (GPRS), Universal Mobile Telephone System (UMTS). Network 150 can also be implemented as a combination of two or more technologies i.e., a hybrid network. Further, network 150 may also include generic Internet access using any transport methods.

It should further be understood that the mobile device 100 may be coupled to a plurality of communication channels that allow the computer to communicate with other computing devices, e.g., servers, processors, etc. over, for example, one or more communication networks. As such, it should be understood that communication channels are examples of communications media, which typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

The mobile device 100 may be able to transmit and receive data over at least one cellular network and at least one wireless local area networking (e.g., “WiFi”) network.

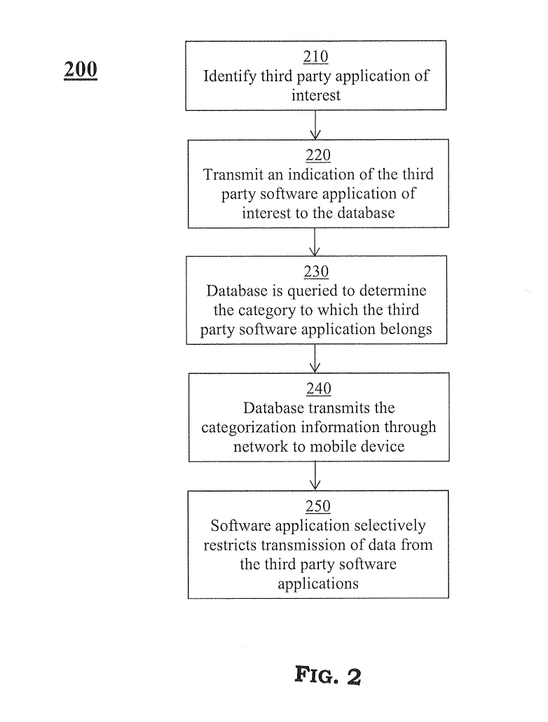

FIG. 2 is a flow diagram 200 showing how the software application 110 may interoperate with the database 140 on server 130 to determine the categories in which each of the third party software applications stored on the mobile device belong. In step 210, the software application 110 identifies a third party application 120a, 120b, or 120c of interest. The identification may be made based on a user attempting to run the third party application 120a, 120b, or 120c; may be made at start-up time of the mobile device 100; may be made on instruction of a user of the mobile device 100; and/or may be made at any other predetermined time.

In step 220, the software application 110 transmits an indication of the third party software application 120a, 120b, or 120c of interest to the database 140. The indication is transmitted over network 150 to server 130, which relays the indication to the database 140.

In step 230, the database 140 is queried to determine the category to which the third party software application 120a, 120b, or 120c belongs. In one illustrative embodiment, the third party software applications 120a, 120b, or 120c fall into one of three categories: Whitelist, Greylist, and Blacklist. For purposes of this illustrative embodiment, as explained, third party software application 120a is in the Whitelist, third party software application 120b is in the Greylist, and third party software application 120c is in the Blacklist. Descriptions of these categories follow:

Whitelist—Third party applications in the Whitelist are deemed safe. This could be because they conduct no malicious activities, they do not serve advertisements, and they do not collect PII. This could also be because the advertisements they serve and/or the PII they collect have been deemed safe or otherwise permissible. The provider of the software application 110 may have a prior agreement in place with application developers of the third party application 120a to ensure its suitability for the Whitelist, may have conducted prior investigation or diligence on third party application 120a to determine its suitability for the Whitelist, or used other techniques to determine its suitability for the Whitelist.

Blacklist—Third party applications on the Blacklist are deemed unsafe, such as through prior investigation or diligence by the provider of software application 110.

Greylist—Applications not on the Whitelist or Blacklist but that make use of mobile device 100's data connectivity functions may be included on the Greylist.

After the database 140 is queried to determine the categories in which third party software applications 120a, 120b, and 120c fall, in step 240 the database server 130 transmits the categorization information through network 150 to mobile device 100 where it is received by software application 110.

In step 250, the software application 110 selectively restricts transmission of data from the third party software applications 120a, 120b, and 120c. Third party software application 120a is in the Whitelist. As such, the software application 110 does not restrict transmission of data to or from third party software application 120a.

Third party software application 120c is on the Blacklist. As such, in one illustrative embodiment, third party software 110 does not allow a user of mobile device 100 to run third party software application 110. In another illustrative embodiment, third party software 110 allows third party software application 120c to launch but disables the data connectivity features of mobile device 100.

Third party software application 120b is on the Greylist. In one illustrative embodiment, software application 110 consults user preferences to determine whether and the manner by which data transmission should be restricted for software application 120b. The user preferences can be selected by, for example, a parent. The user preferences can indicate whether Greylisted third party software application 120b should be allowed to launch with full data connectivity features of mobile device 100 enabled, be allowed to launch with data connectivity features of mobile device 100 disabled, or not be allowed to launch.

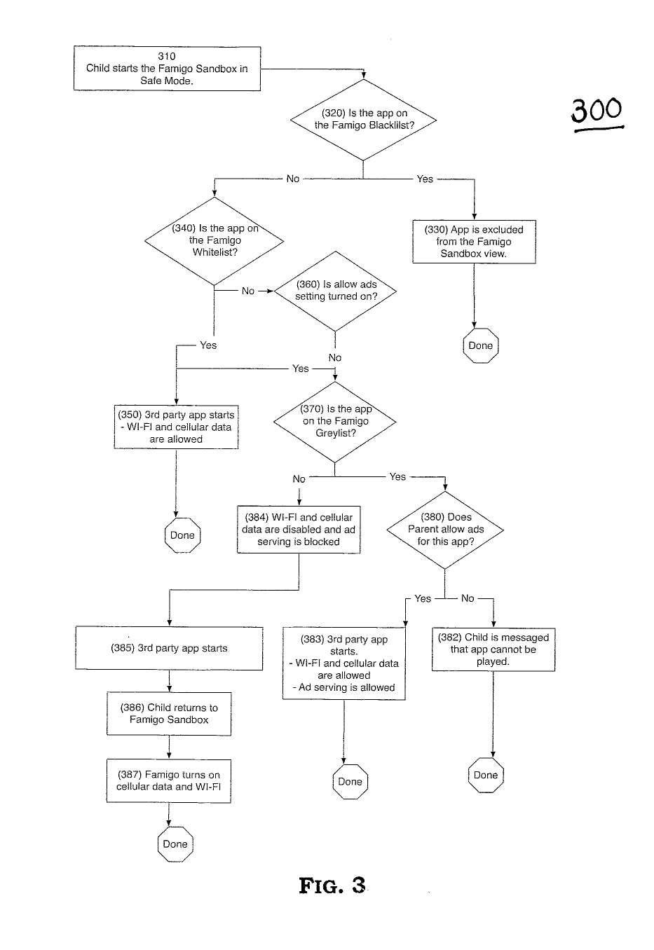

FIG. 3 shows a flow diagram 300 showing in additional detail an exemplary method by which the software application selectively blocks data transmission to or from third party applications depending on the categories to which those third party applications belong. In step 310, a child is operating the mobile device 100 after the software application 110 was invoked. This mode of operation can be referred to as the child being “In the Sandbox in Safe Mode” (or, alternatively, “play mode”) as shown in FIG. 3.

In step 320, the software application 110 determines whether a third party application 120a, 120b, or 120c is on the Blacklist. If it is, the software application 110 proceeds to step 330, which indicates that the third party application 120a, 120b, or 120c is excluded from the “Sandbox view.” In this situation, an icon for the third party application 120a, 120b, or 120c may not be presented to the child, and thus the third party application 120a, 120b, or 120c is prevented from launching.

If the third party application 120a, 120b, or 120c is not on the Blacklist, the software application 110 proceeds to step 340, which determines whether the third party application 120a, 120b, or 120c is on the Whitelist. If so, the software application 110 proceeds to step 350, in which the software application 110 allows the third party application 120a, 120b, or 120c to launch with the mobile device 100's data connectivity enabled.

If the third party application 120a, 120b, or 120c was not on the Whitelist, the software application 110 proceeds to step 360. In this step, the software application 110 consults a setting specifying whether advertisements and/or PII transmission should be allowed for the third party application at hand. If so, the software application proceeds to step 350, thus treating the third party application similar to a Whitelisted application. Otherwise, the software application 110 proceeds to step 370, where it determines whether the third party application 120a, 120b, or 120c is on the Greylist. If so, the software application 110 proceeds to step 380, in which it consults a user preference setting previously selected by the parent as to whether advertisements and/or PII transmission should be allowed for the third party application at hand. If the user preference setting indicates that such data transmission is not allowed, the software application 110 displays a message to the child in step 382 that the third party application 120a, 120b, or 120c cannot be played. If the user preference setting indicates that advertisements and/or PII transmission should be allowed, the software application 110 proceeds to step 383, in which it allows the third party application 120a, 120b, or 120c to be launched and allows the data connectivity features of mobile device 100 to operate.

If the third party application 120a, 120b, or 120c is not on the Greylist, the software application 110 proceeds to step 384, where software application 110 disables the data connectivity features of mobile device 100. The third party application 120a, 120b, or 120c is launched with data connectivity featured disabled in step 385. After completing use of the third party application 120a, 120b, or 120c, the child returns to the “Sandbox” in step 386, after which software application 110 enables data connectivity features of mobile device 100.

In accordance with the disclosed embodiment, if it is determined that advertising or PII transmission should not be allowed for a given third party application, the software application 110 prevents advertisements from being served to the third party application 120a, 120b, or 120c and/or from being displayed to the user of the mobile device 110, and the software application 110 prevents the third party application 120a, 120b, or 120c from transmitting PII over the network 150. The software application 110 may achieve this by disabling the mobile device 100's data connectivity features and/or by preventing the third party application 120a, 120b, or 120c from launching.

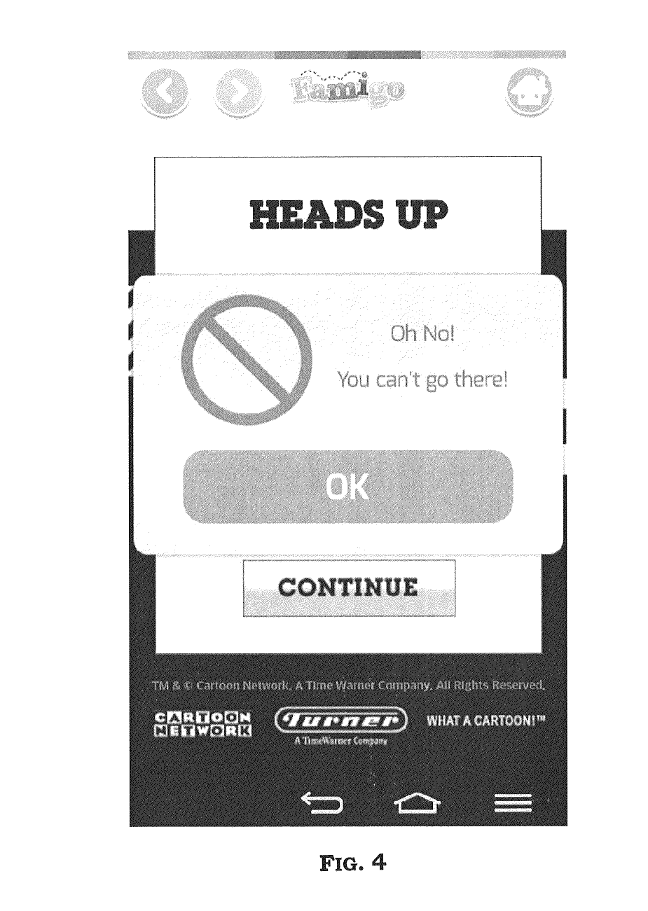

FIG. 4 shows a screen that a child will see when prohibited from accessing a third party application in accordance with the steps described above in connection with FIG. 3, such as step 382.

The mobile device 100 and/or the server 130 may include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Computer-executable instructions comprise, for example, instructions and data which cause a general purpose computer, special purpose computer, or special purpose processing device to perform a certain function or group of functions.

Accordingly, although not illustrated, it should be understood that the mobile device 100 and/or the server 130 may include a processor connected to a user interface, computer readable memory and/or other data storage and a display and/or other output device. The mobile device 100 and/or the server 130 may also include a power supply, and a user interface, such as a keypad, touch screen, voice interface, one or more arrow keys, joy-stick, data glove, mouse, roller ball, touch screen or the like.

Computer executable instructions and data used by a processor included in mobile device 100 and/or server 130 may be stored in the computer readable memory included the respective mobile device 100 and/or server 130. Further, the memory if the mobile device 100 and/or server 130 may be implemented with any combination of read only memory modules or random access memory modules, optionally including both volatile and nonvolatile memory. Further, software may be stored within the memory and/or storage to provide instructions to the mobile device 100 and server 130 for enabling them to perform various functions. Alternatively, some or all of the mobile device computer executable instructions may be embodied in hardware or firmware (not illustrated).

The mobile device 100 includes antennaes for data transmission and reception. Mobile device 110 may have capability to communicate with one or more different types of communication networks and have messaging capabilities including, e.g., a Short Message Service (SMS) client, electronic mail client, or Multimedia Message Service client embedded in mobile device 110. Mobile device 110 may also include a browser configured to access Web and/or Wireless Application Protocol (WAP) services.

It should be understood that memory of mobile device may include many databases that separately include, for example, subscriber profile information, advertising content, archive data, etc. or some combination or all of this information and data may be included in a single database.

It should also be understood that while database 130 has been depicted as being located on a separate server 140, it may also be located directly within mobile device 100.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

Further, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Although certain illustrative embodiments have been described in detail above, variations and modifications exist within the scope and spirit of this disclosure as described and as defined in the claims included in this application.

What is claimed is:

1. A software application stored in a memory in a mobile device for selectively blocking data transmission via a mobile device over a communication network, comprising:
means for identifying a software application of interest from among a plurality of software applications stored in a memory of the mobile device;
means for determining a categorization of the software application of interest based on data provided over the communication network from a database; and
means for selectively restricting transmission of data to or from the software application of interest over the communication network based on the determined categorization,
wherein personally identifiable information is prevented from being transmitted by the software application of interest if the determined categorization indicates that transmission of data to or from the software application of interest is to be restricted.

2. The software application of claim 1, wherein the determined categorization is one of a first category indicating that the software application of interest is not launched, a second category indicating that the transmission of data to or from the software application of interest is restricted, and a third category indicating that no restrictions are placed on the transmission of data to or from the software application of interest.

3. The software application of claim 1, wherein the determined categorization is one of a first category indicating that the software application of interest is not launched, a second category indicating that the transmission of data to or from the software application of interest are governed by user preferences, and a third category indicating that no restrictions are placed on the transmission of data to or from the software application of interest.

4. The software application of claim 3, wherein the user preferences are determined based on selection from among a plurality of preferences received from a user of the mobile device.

5. The software application of claim 4, wherein the plurality of preferences includes a preference that the software application of interest be launched without restricting the mobile device's data connectivity.

6. The software application of claim 1, further comprising means for disabling the mobile device's data connectivity in response to the determined categorization.

7. The software application of claim 1, further comprising means for preventing, in response to the determined categorization, advertisements from the software application of interest from being displayed to a user of the mobile device.

8. The software application of claim 1, further comprising
means for displaying respective icons indicative of each of the plurality of software applications stored on the mobile device; and
means for excluding from the display of the icons an icon corresponding to a software application for which the determined categorization indicates that the software application should not be launched.

9. A method for selectively blocking data transmission on a mobile device, the method comprising:
identifying a software application of interest from among a plurality of software applications stored on the mobile device;
transmitting an indication of the software application of interest to a database operatively coupled to the mobile device;
receiving a categorization of the software application of interest from the database; and
selectively restricting transmission of data to or from the software application of interest based on the determined categorization.

10. The method of claim 9, wherein receiving a categorization of the software application of interest further comprises:
receiving a categorization selected from among a first category indicating that the software application of interest should not be launched, a second category indicating that the transmission of data to or from the software application of interest should be restricted, and a third category indicating that no restrictions should be placed on the transmission of data to or from the software application of interest.

11. The method of claim 9, wherein receiving a categorization of the software application of interest further comprises:
receiving a categorization selected from among a first category indicating that the software application of interest should not be launched, a second category indicating that the transmission of data to or from the software application of interest should be governed by user preferences, and a third category indicating that no restrictions should be placed on the transmission of data to or from the software application of interest.

12. The method of claim 11, further comprising allowing a user to select user preferences for software applications belonging to the second category, wherein
the user preferences can be selected from among a preference that the software application of interest not be launched and a preference that the software application of interest should be launched without restricting the mobile device's data connectivity.

13. The method of claim 9, further comprising disabling, in response to the determined categorization, the mobile device's data connectivity.

14. The method of claim 9, wherein selectively restricting the transmission of data to or from the software application of interest comprises disabling, in response to the determined categorization, at least one of the mobile device's cellular data connectivity and the mobile device's wireless local area network connectivity.

15. The method of claim 9, wherein selectively restricting the transmission of data to or from the software application of interest comprises preventing, in response to the determined categorization, personally identifiable information about a user of the mobile device from being transmitted by the software application of interest.

16. The method of claim 9, wherein selectively restricting the transmission of data to or from the software application of interest comprises preventing, in response to the determined categorization, advertisements from being displayed to a user of the mobile device.

17. The method of claim 9, further comprising
displaying respective icons indicative of each of the plurality of software applications stored on the mobile device; and
excluding from the display of the icons an icon corresponding to a software application for which the determined categorization indicates that the software application should not be launched.

18. A software application for selectively blocking data transmission on a mobile device, the software application comprising:
computer readable code stored on a non-transitory data storage component in operative communication with a processor for the mobile device, wherein the computer readable code, when executed on the processor, causes the mobile device to:
identify a software application of interest;
transmit an indication of the software application of interest to a database operatively coupled to the mobile device;
receive a categorization of the software application of interest from the database; and
selectively restrict transmission of data to or from the software application of interest based on the determined categorization.

19. The software application of claim 18, wherein the categorization is one of a first category indicating that the software application of interest should not be launched, a second category indicating that the transmission of data to or from the software application of interest should be restricted, and a third category indicating that no restrictions should be placed on the transmission of data to or from the software application of interest.

20. The software application of claim 18, wherein the categorization is one of a first category indicating that the software application of interest should not be launched, a second category indicating that the transmission of data to or from the software application of interest should be governed by user preferences, and a third category indicating that no restrictions should be placed on the transmission of data to or from the software application of interest.

21. The software application of claim 20, wherein the user preferences are selected from among a preference that the software application of interest not be launched and a preference that the software application of interest should be launched without restricting the mobile device's data connectivity.

22. The software application of claim 18, wherein the computer readable code, when executed on the processor, further causes the mobile device to disable the mobile device's data connectivity in response to the determined categorization.

23. The software application of claim 18, wherein the computer readable code, when executed on the processor, causes the mobile device to disable, in response to the determined categorization, at least one of the mobile device's cellular data connectivity and the mobile device's wireless local area network connectivity.

24. The software application of claim 18, wherein the computer readable code, when executed on the processor, prevents, in response to the determined categorization, personally identifiable information about a user of the mobile device from being transmitted by the software application of interest.

25. The software application of claim 18, wherein the computer readable code, when executed on the processor, prevents, in response to the determined categorization, advertisements from being displayed to a user of the mobile device.

26. The software application of claim 18, wherein the computer readable code, when executed on the processor, further causes the mobile device to
display respective icons indicative of each of the plurality of software applications stored on the mobile device; and
exclude from the display of the icons an icon corresponding to a software application for which the determined categorization indicates that the software application should not be launched.
